(19) United States
(12) Patent Application Publication
(10) Pub. No.: US 2023/0249377 A1
(43) Pub. Date: Aug. 10, 2023

(54) HEAT-TREATED ENGINEERED WOOD FOR FLOORING

(71) Applicant: LOUISIANA-PACIFIC CORPORATION, Nashville, TN (US)

(72) Inventors: JESSE SCHMITZ, NASHVILLE, TN (US); JARROD KEVIN LINE, BRENTWOOD, TN (US); KEITH T. QUISENBERRY, WHITE HOUSE, TN (US); QINING SUN, FRANKLIN, TN (US); MINA ESKANDER, NOLENSVILLE, TN (US)

(21) Appl. No.: 18/108,499

(22) Filed: Feb. 10, 2023

Related U.S. Application Data
(60) Provisional application No. 63/308,617, filed on Feb. 10, 2022.

(51) Int. Cl. B27K 5/00

(52) U.S. Cl. CPC B27K 5/009; B27K 5/001

(57) ABSTRACT

Thermally-modified panels, boards, and flooring manufactured from engineered wood, including, but not limited to, oriented-strand board (OSB). These products may be in the form of a sub-floor panel or substrate, a board, a panel, a combined panel, tile, or similar form. Heat treatment or thermal modification of wood or wood-based composites provides wood-based products with improved water resistance, dimensional stability, microbial resistance, and related biological durability with reduced use of harmful chemicals and/or the elimination of hazardous chemical pretreatments.

This application claims benefit of and priority to U.S. Provisional App. No. 63/308,617, filed Feb. 10, 2022, which is incorporated herein by specific reference for all purposes.

### FIELD OF INVENTION

This invention relates to a product and method of manufacture for thermally-modified panels, boards, cabinetry components, and flooring manufactured from engineered wood, including, but not limited to, oriented-strand board (OSB), for flooring and various other applications.

### SUMMARY OF INVENTION

In several exemplary embodiments, the present invention comprises thermally-modified panels, boards, and flooring manufactured from engineered wood, including, but not limited to, oriented-strand board (OSB). These products may be in the form of a sub-floor panel or substrate, a cabinet board or panel, a combined panel, tile, or similar form.

Thermal modification of the engineered wood can be performed with either an open process (such as a kiln) or a closed process (such as an autoclave). Heat treating the engineered wood reduces moisture swell in the core substrate of the flooring substrate or panel, thereby providing water durability/resistance and dimensional stability properties.

### BRIEF DESCRIPTION OF THE DRAWINGS

FIG. 1 shows a diagram of a method in accordance with an exemplary embodiment of the present invention.

FIG. 2 shows a cross-sectional view of a panel in accordance with an exemplary embodiment of the present invention.

### DETAILED DESCRIPTION OF EXEMPLARY EMBODIMENTS

In several exemplary embodiments, the present invention comprises thermally-modified panels, boards, and flooring manufactured from engineered wood, including, but not limited to, oriented-strand board (OSB). These products may be in the form of a sub-floor panel or substrate, a board, a panel, a combined panel, tile, or similar form. Heat treatment or thermal modification of wood or wood-based composites is a unique method providing wood-based products with improved water resistance, dimensional stability, microbial resistance, and related biological durability with reduced use of harmful chemicals and/or the elimination of hazardous chemical pretreatments.

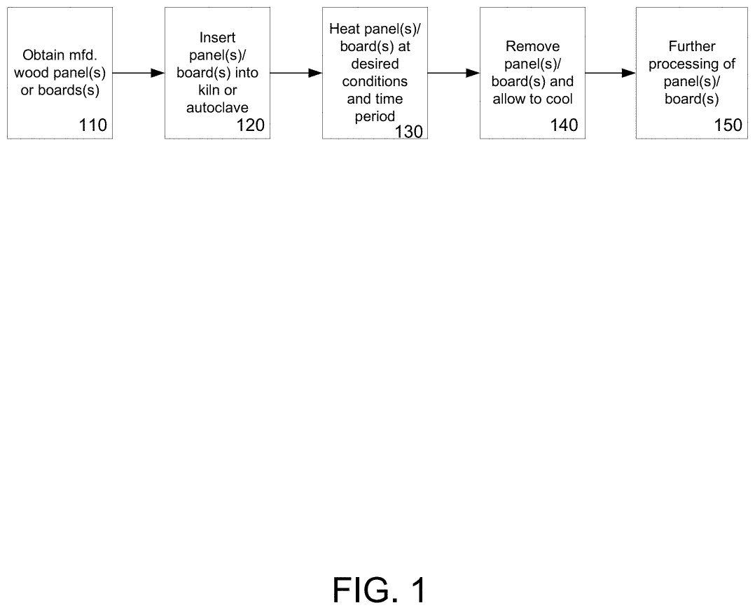

As seen in FIG. 1, thermal modification of engineered wood 110 can be performed with either an open process (such as a kiln) or a closed process (such as an autoclave) 120. The engineered wood is then heated rapidly to a first desired temperature in a range (as discussed below) and desired humidity/moisture levels for a desired time period 130, through the use of heat and/or steam. The temperature may then remain constant, but in several embodiments is gradually increased to a second desired temperature in a range (as discussed below), and maintained there for a period of time. The period of time for which the temperature is maintained in either case may be approximately 1 hour to approximately 5 hours, more preferably approximately 2 hours to approximately 4 hours. The engineered wood is allowed to cool and recover under controlled humidity/moisture level prior to removal 140 (e.g., a water spray may be applied allowing remoisturizing to a desired moisture content, e.g., approximately 2% to approximately 8%, more preferably approximately 3% to approximately 6%, or approximately 4% to approximately 5%). The engineered wood is then further processed for shipment and/or use in constructing desired end products 150. Heat treating the engineered wood reduces moisture swell in the core substrate of the flooring substrate or panel, thereby providing water durability/resistance, and dimensional stability properties.

Heat treatment of wood-based products performs like a controlled pyrolysis of woody biomass being treated at relatively lower temperatures, such as below or equal to 150° C., below or equal to 240° C., in a range of approximately 100° C. to approximately 240° C., in a range of approximately 100° C. to approximately 150° C., or in a range of approximately 150° C. to approximately 240° C., to avoid the total degradation of main components of the wood cell wall. In contrast, conventional pyrolysis converts biomass into energy and chemical products, consisting of liquid bio-oil, solid biochar, and pyrolytic gas, at temperatures ranging from 400° C. to 650° C., resulting in the total degradation of cellulose, hemicellulose, lignin and some extractives existing in the plant cell walls.

The types of heat treatment process vary depending on time and temperature of treatment (e.g., ramp-up, hold and ramp-down stages), treatment atmosphere (e.g., inert gas, air, vacuum, oil), open (e.g., kiln) or closed (e.g., autoclave) systems, wood species (hardwoods and softwoods), and dry (wood being dried to close to zero moisture content before heat treatment) or wet (saturated steam as the heating medium or hot water immersion/extraction) systems. The properties and performances of finished woody products are dependent on the key variables selected and used in the heat treatment.

Heat treatment in the presence of oxygen or air can introduce more oxygen containing or oxidized functional groups, such as acetic acid, formic acid, aldehydes generated from hemicellulose and cellulose side chains, and phenolic acids from lignin breakdown. These organic acids will eventually increase the acidity of treated woody products, and promote the release of small fractions derived from depolymerized hemicellulose and lignin as volatile organic compounds (VOCs). In contrast, heat treatment in the absence of oxygen will leave the finished products with less carbonyl, carboxyl, and hydroxyl groups, which thereby improve their hydrophobicity.

In a dry system, heat treatment leads to dehydration products such as furfurals, which have potential to repolymerize and form insoluble hydrophobic materials in the cell wall. This contributes to the improvement in hydrophobicity.

In the wet system of heat treatment, steam under heat and pressure may play a role as a weak acid in depolymerizing hemicellulose and amorphous cellulose, and transforming a portion of them into aromatic materials (e.g., pseudo-lignin), which are main contributors for the enhancement of dimensional stability and hydrophobicity of heat-treated woody products.

Heat-induced physicochemical changes in wood occur with varying treatment intensities and conditions, which mostly result from the structural and morphological changes of cell wall components (cellulose, hemicellulose, lignin) and extractives. For example, the darkening of wood is mainly attributed to the formation of colored degradation products from hemicelluloses and extractive compounds, and transformation of lignin into quinones like biopolymers. Improved dimensional stability may also result from possible hornification, the irreversible stiffening and shrinking of internal fiber volume of lignocellulosic materials upon drying or water removal during the thermal process. Reduced wood wettability and water permeability accompanying increased hydrophobicity are also attributed to the following hornification-associated effects: (1) decrease in the water retention value, specific surface area, and pore size of the cell wall of aggregated cell wall structures; (2) the increase in cellulose crystallinity and crystallite size; (3) the degradation and transformation of hemicellulose and lignin into crosslinked and hydrophobic biopolymers; and (4) the loss of predominantly oxygen-containing hydrophilic groups.

Heat treatment as described herein, and the accompanying changes in cell wall ultrastructure and components, reduces water uptake and expansion and moisture swell in the core substrate, thereby providing increased water resistance/durability, increased dimensional stability, reduced linear expansion, and reduced warping.

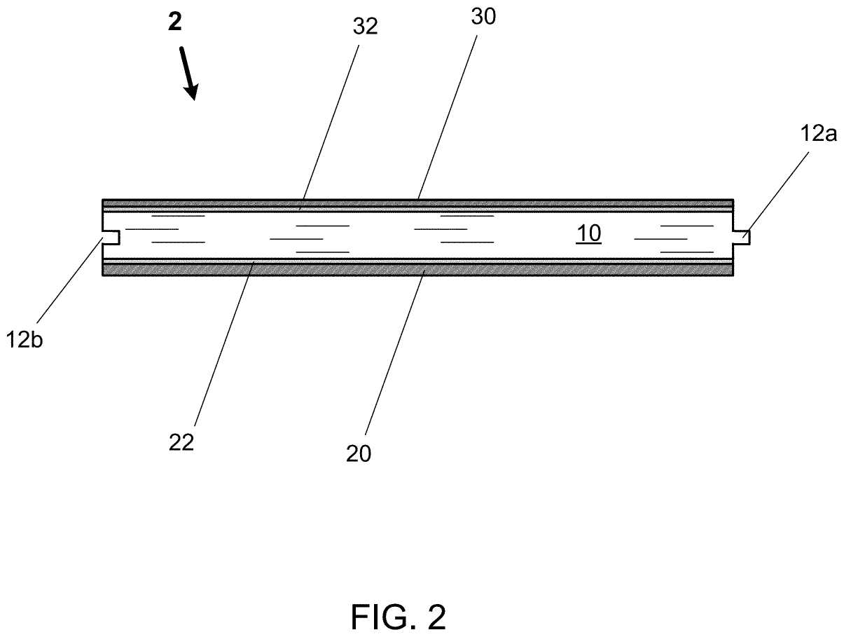

FIG. 2 shows an example of an end product (i.e., veneer panel with backer) 2 using heat-treated OSB produced as described above. The main substrate is heat-treated OSB 10, with ends or edges formed into respective tongue-and-groove joint elements 12a, b. A rubber or polymer backer 20 is affixed via hot melt glue lamination 22 to the back face of the heat-treated OSB substrate, and a sliced or rotary veneer layer 30 is affixed via hot melt glue lamination 32 to the front face of the heat-treated OSB substrate, opposite the backer.

Thus, it should be understood that the embodiments and examples described herein have been chosen and described in order to best illustrate the principles of the invention and its practical applications to thereby enable one of ordinary skill in the art to best utilize the invention in various embodiments and with various modifications as are suited for particular uses contemplated. Even though specific embodiments of this invention have been described, they are not to be taken as exhaustive. There are several variations that will be apparent to those skilled in the art.

What is claimed is:

1. A method of producing treated wood, comprising the steps of:
providing one or more wood-based pieces;
inserting the one or more wood-based pieces into a kiln or autoclave;
heating the one or more wood-based pieces to a set temperature under prescribed moisture conditions;
maintaining the one or more wood-based pieces at the set temperature for a prescribed period of time; and
cooling the one or more wood-based pieces to a set cooling temperature.

2. The method of claim 1, wherein the wood-based pieces comprise engineered-wood.

3. The method of claim 2, wherein the engineered-wood comprises oriented strand board.

4. The method of claim 1, wherein the set temperature is below or equal to 150° C.

5. The method of claim 1, wherein the set temperature is below or equal to 240° C.

6. The method of claim 1, wherein the set temperature is in a range of approximately 100° C. to approximately 240° C.

7. The method of claim 1, wherein the set temperature is in a range of approximately 100° C. to approximately 150° C.

8. The method of claim 1, wherein the set temperature is in a range of approximately 150° C. to approximately 240° C.

9. The method of claim 1, wherein the period of time is in a range of approximately 1 hour to 5 hours.

10. The method of claim 1, wherein the period of time is in a range of approximately 2 hours to 4 hours.

11. A manufactured wood product produced according to the method of claim 1.

12. A panel or board produced according to the method of claim 1.

13. The product of claim 11, wherein the product is a sub-flooring panel.

14. The product of claim 11, wherein the product is a flooring tile.

15. The product of claim 11, wherein the product is a cabinet component.
